(19) United States
(12) Patent Application Publication
(10) Pub. No.: US 2013/0268427 A1
(43) Pub. Date: Oct. 10, 2013

(54) TERMINAL FOR TRADING ON THE EXCHANGE MARKETS

(71) Applicants: Ilya Vladimirovich Kligman, St. Petersburg (RU); Sergey Vladimirovich Migalev, Rostov-na-Donu (RU)

(72) Inventors: Ilya Vladimirovich Kligman, St. Petersburg (RU); Sergey Vladimirovich Migalev, Rostov-na-Donu (RU)

(21) Appl. No.: 13/994,728

(22) PCT Filed: Dec. 30, 2010
(86) PCT No.: PCT/RU2010/000807

§ 371 Date: Jun. 15, 2013

(51) Int. Cl. G06Q 40/04

(52) U.S. Cl. CPC G06Q 40/04
USPC 705/37

(57) ABSTRACT

A system for financial transactions includes a terminal for trading on the exchange markets, comprising a monitor for displaying target information with a keyboard-type input device, a money input device for financial operations, as well as with communication devices for remote servers and a computing device for graphic information displaying and for settlement transactions. The computing device broadcasts quotations received from exchange markets and can transfer, by a signal of trading session termination, of a profit to current account of the payer or distribution of the profit through an integral cash dispenser. The terminal has a unit of the position or transaction amount choice and limiting of risks to the amount of this position or transaction, and the computing device can calculate transaction calculation, input of the price of change of at least one rate and input of increased or decreased position or invariance position of a future quotation.

### CROSS-REFERENCE TO RELATED APPLICATIONS

The application is a National Phase of PCT/RU2010/000807, filed on Dec. 30, 2010, incorporated herein by reference in its entirety.

### BACKGROUND OF THE INVENTION

The invention relates to the systems for financial transactions, and to providing fast trading and fast distribution of material remuneration as a result of trading.

Conventional art teaches an exchange trading system comprising of a computer; a plurality of information sets about tendering received by the computer, where each of the information sets about tendering describes trading session of the first trader; a plurality of information sets about quotas of the trading received by the computer, where each of the information sets about quotas of the trading describes trading held by the order of the second trader; a set of the preset acceptable parameters of trading and software features carried out by the computer to compare information sets about tendering with information sets about quotas of the trading and to define coincidences if information set about tendering and information set about quotas of the trading conform within a set of preset acceptable trading parameters (see RU Patent No. 2259586).

A disadvantage of the conventional systems is its complexity not only in hardware but also in insufficient functionality that excludes remote access to the trading of other persons who are not officially registered for participation in trading.

Conventional art also teaches a remote communication terminal for trading on the exchange markets, comprising of a monitor and a push-button or touch keyboard or a touch monitor with a keyboard on a monitor screen, a payment card reader, a money input system, a device for remote connection in the form of a programming and computing unit having feature of graphic interface displaying with the fields for target information displaying, with the relevant control server for the user's account state, as well as a money output device. The programming and computing unit has a remote connection with servers of the exchange markets and information agencies for displaying in the specified fields of information about the current quotations, stakes/positions and calculation of profit and loss for each transaction. The unit also has a feature of displaying of positions, with a feature of input of the price for a point change and a position amount through the keyboard and transfer of a premium to the account of a payment card holder or output of a premium through a money output device (RU Patent No. 64405, 2007).

The disadvantage of this solution is that for trading on such terminal, the user needs particular skills or special knowledge to correctly take a market position. Given that that for certain real periods there are probabilistic estimates of possible positions on the basis of earlier received results and approximations or correlations, it is possible to receive rather probabilistically reliable data on the future quotations that increases probability of the user's success at the trading.

### DETAILED DESCRIPTION OF THE PREFERRED EMBODIMENTS

Additional features and advantages of the invention will be set forth in the description that follows, and in part will be apparent from the description, or may be learned by practice of the invention. The advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

The chief matter of invention is implementation of the terminal for simple trading. Such terminal is qualified as the gaming equipment and can be placed in game clubs, casinos and club-type resting places.

The terminal is operated according to the principles of FOREX international exchange market. To ensure normal operation of such a terminal, it is necessary to provide real time broadcasting of the currency market quotations for the securities on that terminal and to implement the profit calculation algorithm for transactions made by a client.

Quotations source can be both widely known information sources—“Reuters”, “Bloomberg”, “Tenfore”, and dealing centers providing access to trade operations on FOREX market through the Internet.

Also, transactions made through the terminal can be introduced, through one of the dealing centers, to the real market, which makes such terminal not just a gambling equipment, but a remote terminal for the stock exchange transactions.

The object of the present invention is to achieve the technical result of convenience in the terminal operation at the financial transactions complying with the automated mode of limiting risks by using a mode of automated calculation of increased and decreased positions or unchanged position of at least one future position or quotation.

The claimed technical result is achieved in that the terminal for trading on the exchange markets, comprising of a monitor for displaying of target information with a keyboard-type input device, a money input device for financial operations, as well as with communication devices for remote servers and a computing device for graphic information displaying in the fields of an interface displayed on the monitor screen and for settlement transactions. The computer can broadcast quotations received from the exchange markets or financial information agencies and can transfer, by a signal of the trading session termination, of a premium or profit to the current account of the payer or distribution of the profit through the payment device. The computer also has a unit of the position or transaction amount choice and limiting of risks to the amount of this position or transaction. The computing device has an additional option of implementation of feature of transactions calculation, inputting of the price of change of at least one rate and input of increased or decreased position or an unchanged position of at least one future quotation.

The specified features provide the desired technical result.

The present invention is explained by specific case of embodiments which, however are not unique, but demonstrate possibility of achievement of the claimed technical result.

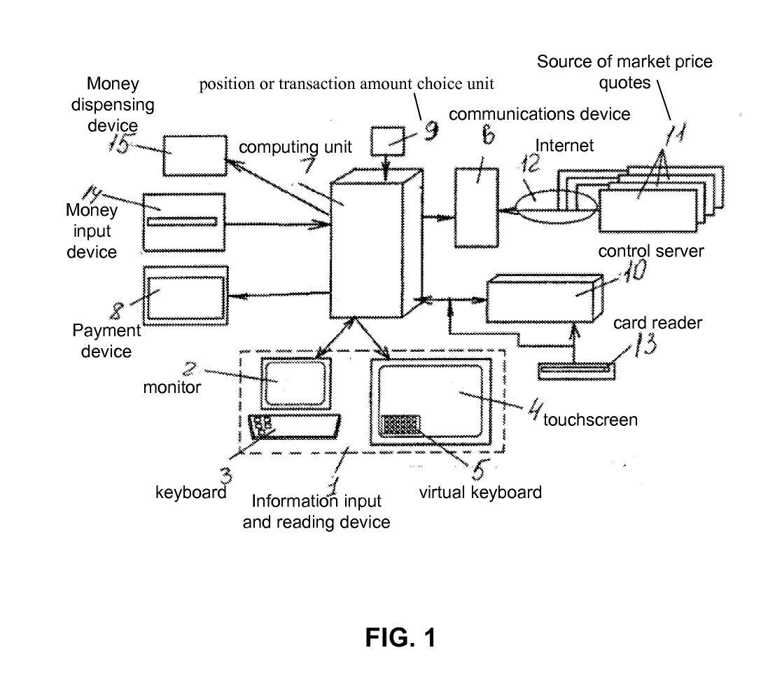

FIG. 1 shows a diagram of the terminal. The remote communication terminal for trading on the exchange comprises information input and reading device 1 in the form of a monitor 2 and a push-button or touch keyboard 3 or a touchscreen monitor 4 with a keyboard 5 on the monitor screen, a communications device 6 with remote servers and a computing unit 7 having a feature of graphic information displaying in the interface, displayed on the monitor screen and of settlement operations execution. The computing device has a feature of quotations broadcasting received from the exchange markets or information agencies and with a feature of transfer, by a signal of the trading session termination, of a premium to the current account of the payer or distribution of a premium or profit through the payment device 8. Also, the computing device has an additional option of implementation of feature of transactions calculation, input of the price of change of at least one rate and input of increased or decreased position or invariance position of at least one future quotation.

The terminal has a position or transaction amount choice unit 9 for limiting of risks to the amount of this position or transaction.

The computing unit is connected on the one side with the relevant control server 10 or the user's account state, for example the bank issuing a payment, (for example, credit and financial) card if the access to the trader's account is provided through the card, and on the other side with a source(s) of quotations 11 and other exchange information, such as—“Reuters”, “Bloomberg”, “Tenfore”, and dealing centers providing access to the trade operations on the FOREX market on the Internet 12).

Besides, the terminal comprises, for example, a financial and credit card reader 13, directly or remotely connected to the control server 10 for the user's account state.

The terminal also comprises the money input device 14 and a cash dispensing device 15 that allows to pay for the position and to receive money at the terminal location. The device 13 can be built into the terminal case, or located outside the latter at a distance, and connected with the programming and computing unit. This unit can transfer of funds to the user's account, but also of withdraw specified amounts from the user's account and/or dispensing of these amounts. Such a construction allows to use various mechanisms of account crediting and to use proximity cards (which work on the principle of credit cards, but to withdraw the funds it is necessary just to bring the card close to the device (to rest or bring it to a distance of not more than 10 cm), payments by means of a mobile telephone set, electronic payment systems, account and password in the sponsoring organization, cash and card reader: on the terminal, in the institution's box office, scratch cards (issued with the fixed face value (a 500-roubles or $20 card, a code field is rubbed, a code is entered to the device).

The device 6 remotely connects to the server(s) of the exchange and financial data agencies for displaying on the monitor's screen in the specified fields of information about the current quotations, positions and calculation of profit and loss for each transaction. The specified unit also has a feature of displaying of the positions made, with a feature of input of the price for a rate (point) change and a position amount through the keyboard and transfer of a premium to the account of a credit and financial card holder or output of a premium through a cash dispensing device.

To simplify access to the terminal and transfer of the amount into the trading account of the client, it can be additionally equipped with a dactyloscopic (fingerprint) control and authentication system. The terminal can also be additionally equipped with a voice control system. These terminal features allow to control the user's authenticity and verify his identity.

During a session, a client chooses a trade transaction (for example—a currency pair) and cost of at least one minimum price change for this trade transaction. Next, according to its expectations and the current quotations feed, a client takes a position by executing a commercial transaction for purchase or sale of a trade transaction. According to the current quotations feed, the terminal calculates the client's profit (loss) amount and displays to the client the generated cash balance. The client can at any moment close its position by execution of an opposite transaction (to buy if he was selling or vice versa).

Thus one game cycle comes to the end. The number of game cycles within one session is limited only to the cash balance. The game cycle can be terminated forcibly if the price changes for the chosen trade transaction led to the fact that the cash balance is zero.

One advantage of the invention is that there is no need for complex and long-term procedures of preliminary client's registration, bank accounts opening, or transfer of money to the trading center. All operations and settlements with the client are carried out directly through the terminal on site.

The terminal is an essentially new game device and will contribute to acquisition of new clients, since there are no other available game systems as simple as this system is. From the clients' point of view, the terminal is attractive because it operates on the basis of world quotations of securities. These quotations can be easily checked through alternative information sources (such as TV channels and the Internet publications) that makes impossible to manipulate with quotations in favor of an organization where a terminal is installed, and significantly reduces incidences of fraud.

The programming and computing unit is described, for example in the book of Olga Degtyareva, Olga Kandinskaya “Stock-exchange industry: University textbook”, M, Banks and exchanges, UNITI, 1997 503 pages, ISBN 5-85173-060-9, chapter 7 “Development of electronic exchange trading system”, section 7.3 “Electronic Algorithms for Trading”, section 7.4.2 “Illustration of Electronic Trading Operation (by the example of ATC/2 System)” (an electronic version of this section is attached), presented in 2003 on the official site “Olga Kandinskaya's Economic Site” online and which can be found out at http:**kandinskaya.narod.ru/delo07_r.html, incorporated herein by reference.

In this book there are examples of implementation of the main electronic exchange components, including calculations algorithm, interaction schemes, usage of software and hardware by the example of computers of 386 and 486 series. In particular, the example of electronic trading operation using ATC/2 system is provided in detail. Under a transactions algorithm, described in this book, is understood the transactions scenario, that is a sequence of actions and a set of conditions under which an object is purchased and sold. Therefore, such feature as “the computing device accepting positions/trades and calculation of profit and loss for each transaction” in relation to the modern state of art are known in the field of exchange transactions.

The present invention is industrially applicable as it can be implemented using technologies applied in production of electronic and mechanical gaming machines and computerized remote access systems.

Having thus described a preferred embodiment, it should be apparent to those skilled in the art that certain advantages of the described method and apparatus have been achieved. In particular, those skilled in the art would appreciate that the proposed system and method provide for efficient processing of the system errors caused by execution or installation of the software applications.

It should also be appreciated that various modifications, adaptations and alternative embodiments thereof may be made within the scope and spirit of the present invention. The invention is further defined by the following claims.

What is claimed is:

1. A terminal for trading on the exchange markets, comprising
a monitor having a keyboard-type input device and configured to display financial information;
a money input device for financial operations connected to the monitor;
a cash dispenser connected to the monitor;
a communication device for communicating with a remote server;
a computing device for displaying graphic information on the monitor screen and for settlement transactions,
wherein the computing device displays securities quotations received from the exchange markets;
wherein the computing device is configured to transfer, upon a signal indicating a trading session termination, a profit to a current account of the payer or distribution of the profit through the cash dispenser; and
a unit of the position or transaction amount choice, coupled to the computing device, wherein the unit limits risks to an amount of a current position or transaction.

2. The terminal of claim 1, wherein the computing device calculates a transaction value based on an input of the price of change of at least one rate and input of increased or decreased position or an unchanged position at least of one future quotation.
